(19) United States
(12) Patent Application Publication
(10) Pub. No.: US 2023/0032525 A1
(43) Pub. Date: Feb. 2, 2023

(54) NETWORK CONNECTED APPARATUS AND CLOUD DATA PROCESSING METHOD

(71) Applicant: QNAP SYSTEMS, INC., New Taipei City (TW)

(72) Inventors: Jing-Wei Su, New Taipei City (TW); Chin-Tsung Cheng, New Taipei City (TW)

(73) Assignee: QNAP SYSTEMS, INC., New Taipei City (TW)

(21) Appl. No.: 17/500,939

(22) Filed: Oct. 14, 2021

(30) Foreign Application Priority Data
Jul. 30, 2021 (TW) 110128185

(51) Int. Cl. H04L 29/08

(52) U.S. Cl. CPC H04L 67/1095

(57) ABSTRACT

A network-connected apparatus and a cloud data processing method are provided. In the method, a file is stored in one or more local storages which include a cloud-synchronized folder. The file is uploaded to a remote storage. The cloud-synchronized folder stores the metadata of the files uploaded to the remote storage. The metadata of the file is identified. One or more computing resources are triggered according to the identified result of the metadata. Each computing resource is used for providing computing services on the file. Accordingly, resources may be properly used, and computing efficiency may be enhanced.

### CROSS-REFERENCE TO RELATED APPLICATION

This application claims the priority benefit of Taiwan application serial no. 110128185, filed on Jul. 30, 2021. The entirety of the above-mentioned patent application is hereby incorporated by reference herein and made a part of this specification.

### BACKGROUND

### Technology Field

The disclosure relates to data processing technology, and particularly, to a network-connected apparatus and a cloud data processing method.

### Description of Related Art

Cloud storage services allow various authorized devices to back up and access files, thereby further simplifying the operation process and providing secure backup options. In some cloud backup mechanisms, cloud-synchronized folders are provided. For example, FIG. 1 is a schematic view illustrating a conventional cloud backup. Referring to FIG. 1, if a file F1 in a local storage LS is stored in a cloud-synchronized folder CF (step S1), the file F1 may be further uploaded to a remote storage RS (step S2). To save local space, the file F1 may be deleted from the local storage LS (step S3).

Noticeably, a program p (e.g., file system, video browsing, or audio editing program) of the local device may access the file F1 (step S4-1). The file F1 in the local storage LS has been deleted, so it requires to download the file F1 from the remote storage RS (step S4-2). However, the operation of the program p may consume local hardware and software resources. Moreover, if the local device frequently accesses the file F1 in the cloud-synchronized folder CF, the network bandwidth may be occupied, and the processing efficiency may be affected.

### SUMMARY

In view of this, the embodiments of the disclosure provide a network-connected apparatus and a cloud data processing method capable of offloading computing to a cloud platform and improving the computing efficiency.

The cloud data processing method in the embodiments of the disclosure includes (but is not limited to) steps as follows. A file is stored to a cloud-synchronized folder. One or more local storages include the cloud-synchronized folder. The file is uploaded to a remote storage. The cloud-synchronized folder stores metadata of the file uploaded to the remote storage. The metadata of the file is identified. One or more computing resources are triggered according to an identified result of the metadata. Each computing resource is used to provide a computing service to the file.

The network-connected apparatus in the embodiments of the disclosure includes (but is not limited to) a communication transceiver, a first storage, and a processor. The communication transceiver is used for transmitting or receiving data. The first storage is used for storing a program code. The processor is coupled to the communication transceiver and the first storage. The processor is configured to load and execute the program code to execute the following. A file is stored to a cloud-synchronized folder. The file is stored to the first storage or the file is uploaded to a second storage through the communication transceiver. Metadata of the file is identified. Moreover, one or more computing resources are triggered according to an identified result of the metadata. The first storage includes the cloud-synchronized folder. The cloud-synchronized folder stores the metadata of the file. The second storage is not located in the network-connected apparatus. Each computing resource is used to provide a computing service to the file.

In summary, the network-connected apparatus and the cloud data processing method according to the embodiments of the disclosure provide corresponding computing resources according to the metadata of the files stored in the cloud-synchronized folder. Accordingly, computing operations may be facilitated, computing operations may be appropriately offloaded to other resources, and software and hardware resources may be effectively used.

In order to make the features and advantages of the disclosure comprehensible, embodiments accompanied with drawings are described in detail below.

### BRIEF DESCRIPTION OF THE DRAWINGS

FIG. 1 is a schematic view illustrating a conventional cloud backup.

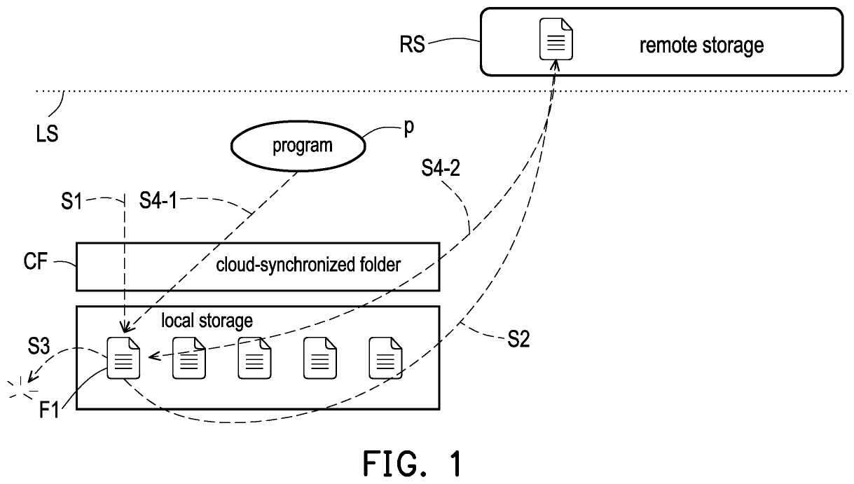

FIG. 2 is a block view of the components of a data processing system according to an embodiment of the disclosure.

FIG. 3 is a flowchart illustrating a cloud data processing method according to an embodiment of the disclosure.

FIG. 4 is a flowchart illustrating computing data decision according to an embodiment of the disclosure.

FIG. 5 is a flowchart illustrating thumbnail processing according to an embodiment of the disclosure.

FIG. 6 is a flowchart illustrating intelligent monitoring according to an embodiment of the disclosure.

FIG. 7 is a flowchart illustrating multi-device sharing according to an embodiment of the disclosure.

### DESCRIPTION OF THE EMBODIMENTS

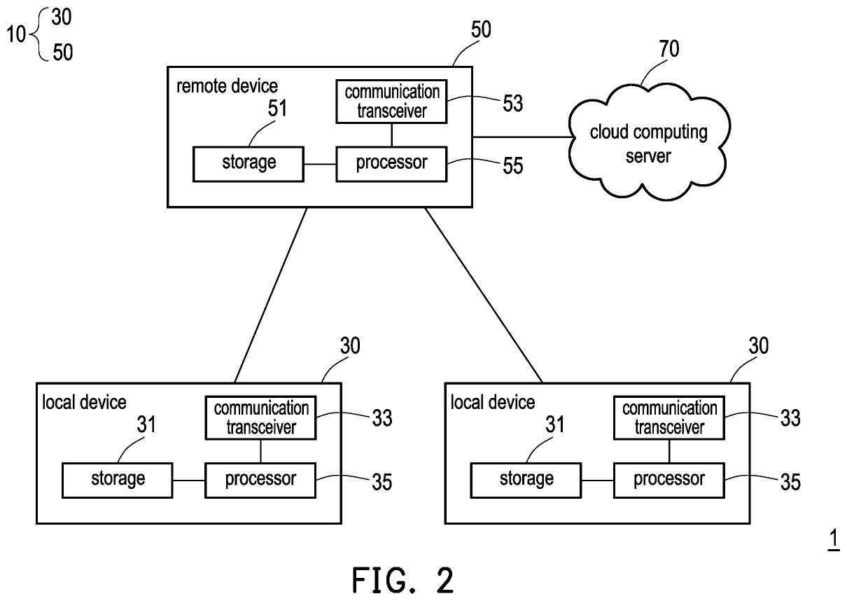

FIG. 2 is a block view of the components of a data processing system 1 according to an embodiment of the disclosure. Referring to FIG. 2, the data processing system 1 includes (but is not limited to) one or more network-connected apparatuses 10 and one or more cloud computing servers 70.

In one embodiment, the network-connected apparatus 10 is a local device 30. The local device 30 may be a mobile phone, a tablet computer, a laptop computer, a desktop computer, a server, a network attached storage (NAS) device, a smart home appliance, a voice assistant, or other electronic devices. The local device 30 includes (but is not limited to) a storage 31, a communication transceiver 33, and a processor 35.

The storage 31 (or the local storage LS) may be any type of fixed or removable random access memory (RAM), read only memory (ROM), flash memory, a traditional hard disk drive (HDD), a solid-state drive (SSD), or the like. In one embodiment, the storage 31 is used to store program codes, software modules, configuration configurations, data, or files (e.g., images, videos, music, or documents).

The communication transceiver 33 supports transceivers (which may include, but are not limited to, components such as connection interfaces, signal converters, communication protocol processing chips, and the like) for wired networks such as Ethernet, optical fiber networks, cables, and the like. The communication transceiver 33 may also support transceivers (which may include, but are not limited to, components such as antennas, digital-to-analog/analog-to-digital converters, communication protocol processing chips, and the like) for wireless networks such as Wi-Fi, fourth generation (4G), fifth generation (5G), or latest generations of mobile networks. In one embodiment, the communication transceiver 33 is used to transmit or receive data.

The processor 35 is coupled to the storage 31 and the communication transceiver 33. The processor 35 may be a central processing unit (CPU), a graphics processing unit (GPU), other programmable general-purpose or special-purpose microprocessors, a digital signal processor (DSP), a programmable controller, a field programmable gate array (FPGA), application-specific integrated circuits (ASICs), other similar components, or a combination thereof. In one embodiment, the processor 35 is used to perform all or part of the operations of the local device 30 and may load and execute various software modules, files, and data stored in the storage 31.

In one embodiment, the network-connected apparatus 10 is a remote device 50. The remote device 50 may be a mobile phone, a tablet computer, a laptop computer, a desktop computer, a server, a network attached storage device, a smart home appliance, a voice assistant, or other electronic devices. The remote device 50 includes (but is not limited to) a storage 51, a communication transceiver 53, and a processor 55.

Refer to the descriptions of the storage 31, the communication transceiver 33, and the processor 35 for the implementation and functions of the storage 51 (or the remote storage RS), the communication transceiver 53, and the processor 55, which are not iterated herein. In one embodiment, the processor 55 is used to perform all or part of the operations of the remote device 50 and may load and execute various software modules, files, and data stored in the storage 51.

In one embodiment, the local device 30 and the remote device 50 may be connected via a network, and the network may be a local area network, the Internet, or other types of networks.

The cloud computing server 70 (or a cloud computing platform) may be a tablet computer, a laptop computer, a desktop computer, various types of servers, a network attached storage device, or other electronic devices. In one embodiment, the cloud computing server provides computing services. The computing services may be related to services such as thumbnail processing, image recognition, image coding, monitoring and analysis, document editing, file conversion, and the like and may vary according to the needs of the users. For example, services provided by OpenFaaS, Lambda, or Azure functions.

In the subsequent paragraphs, the method according to the embodiment of the disclosure is illustrated with reference to various devices, components, and modules in the data processing system 1. Each process of the method may be adjusted according to the implementation, and the disclosure is not limited thereto.

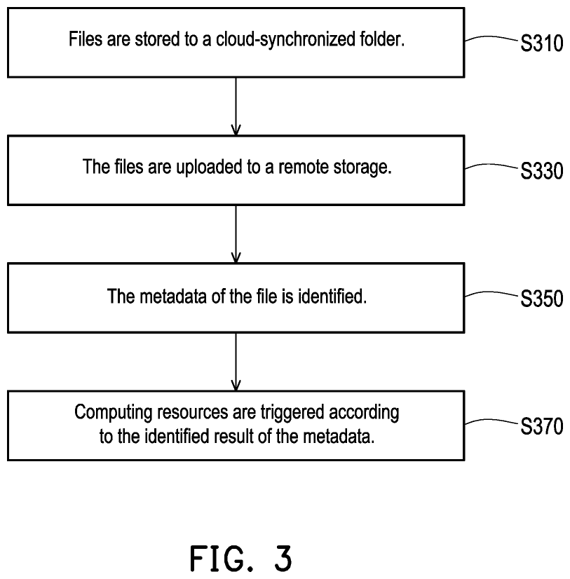

FIG. 3 is a flowchart illustrating a cloud data processing method according to an embodiment of the disclosure. Referring to FIG. 3, the processor 35 of the local device 30 stores files to a cloud-synchronized folder (step S310). Specifically, the file systems of the local device 30 and the remote device 50 provide cloud-synchronized folders. The file systems provide files and tree/hierarchy directories (or folders), and it becomes convenient for the users to store or access specific files (e.g., files, music, images, or videos) through specific directories (or folders). The cloud-synchronized folder is a folder for cloud storage services.

In one embodiment, the local device 30 regards the remote device 50 as a network hard disk (or cyberspace or a cloud hard disk). That is, the remote device 50 provides cloud storage services. The cloud-synchronized folder of the local device 30 corresponds to a specific folder in the remote device 50. That is, the storage 31 and the storage 51 include corresponding cloud-synchronized folders. The processor 35 may respond to storage conditions (e.g., the file system, image recording, image capture, voice recording, or automatic backup mechanism, such as timing or saving new files, operated by the users), and then the processor 35 stores the corresponding files in the cloud-synchronized folder.

In response to storing files in the cloud-synchronized folder, the processor 35 may upload files to the storage 51 of the remote device 50 via the communication transceiver 33 and via the network, and/or the processor 55 may store the files in the storage 51 (equivalent to the remote storage RS) (step S330). In one embodiment, the processor 35 may delete the file uploaded to the storage 51 or its cache, and the processor 35 stores the metadata of the file uploaded to the storage 51 in the cloud-synchronized folder of the local device 30 and the remote device 50. The metadata is used to describe the specific system data of the file. In one embodiment, the metadata includes at least one of a file format, a main/subdirectory, and an extended attribute (e.g., owner, access rights, and the like). In another embodiment, the metadata includes file name, file length, creation/modification timestamp, and/or other attributes.

In some embodiments, if the cloud storage services of several local devices 30 are all configured with the same account or the account that allows sharing, some or all of the cloud-synchronized folders in the local devices 30 may store the metadata of the same file for the local devices 30 to access the file. In other embodiments, even if the file is uploaded to the storage 51, both the file and its metadata may still be stored in the storage 31 and may not be deleted.

The processor 35 of the local device 30 or the processor 55 of the remote device 50 may identify the metadata of the file (step S350). Specifically, the processor 35 or the processor 55 may set the configuration (or strategy) of the cloud-synchronized folder according to the input operation of the user or the loading action of the configuration file. The configuration is generated according to application requirements (e.g., monitoring, encoding, file conversion, image analysis, etc.) and/or needs of the user (e.g., custom operations and automation functions). The configuration records the subsequent operations or processing services of specific metadata. For example, remote computing, cloud non-server computing, or disposing cloud graphics processing units.

In one embodiment, the processor 35 or the processor 55 sets the configuration to the metadata of one or more files under the cloud folder. That is, the configuration may be for the specified metadata in the file. One example is the image file format in the metadata. Another example is the picture subdirectory in the metadata. On the other hand, the configuration is related to the use of one or more computing resources. The computing resource includes cloud computing and local computing. The cloud computing is a computing service provided by the cloud computing server 70 or the remote device 50. The local computing is the computing service provided by the local device 30. In one embodiment, the configuration further records the correspondence between metadata and computing resources. One example is that the image file format corresponds to cloud resources. Another example is that the picture subdirectory corresponds to cloud resources. Yet, another example is that the file folder format corresponds to local resources.

According to different metadata management mechanisms (centralized or distributed management), the processor 35 or the processor 55 may access the metadata of the specified file in a specific file control block (FCB) and identify one or more specified metadata. The specified metadata may be recorded in the configuration or other control commands.

The processor 35 or the processor 55 may trigger one or more computing resources according to the identified result of the metadata (step S370). Specifically, each computing resource is used for providing computing services on the file. Because the configuration includes the correspondence between specific metadata and computing resources, in one embodiment, the processor 35 or the processor 55 may compare at least one of the file format, subdirectory, and extended attribute with those computing resources in the correspondence (i.e., cloud computing and/or local computing), and the processor 35 or the processor 55 uses the corresponding computing resources according to the comparison result of the metadata. The comparison result is whether the metadata of the file corresponds to the file format, subdirectory, and/or extended attribute in the correspondence or not. Moreover, the processor 35 or the processor 55 may call the corresponding computing service according to the configuration for the corresponding file format, subdirectory and/or extended attribute. In another embodiment, the processor 35 or the processor 55 may also compare the file name, modification time, or other metadata attributes of the file and provide corresponding computing resources accordingly.

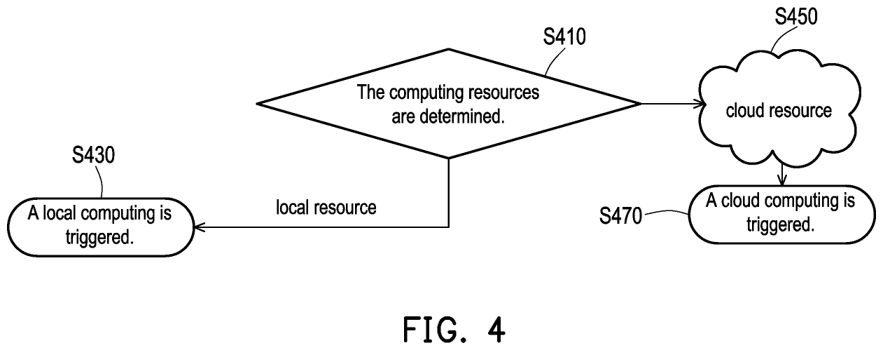

FIG. 4 is a flowchart illustrating computing data decision according to an embodiment of the disclosure. Referring to FIG. 4, the processor 35 or the processor 55 determines whether the computing resource is a local resource or a cloud resource (step S410). If the metadata of the specific file stored in the cloud-synchronized folder corresponds to the local resource in the configuration, the processor 35 or the processor 55 performs a local computing on the file (step S430). The local computing refers to computing processing using the hardware and software resources (i.e., local resources) of the local device 30. On the other hand, if the metadata of a specific file stored in the cloud-synchronized folder corresponds to the cloud resource in the configuration, then the processor 35 calls the remote device 50 to request cloud resources or calls the processor 55 of the remote device 50 to directly request cloud resources through the communication transceiver 33 (step S450), and accordingly the cloud resources are used to trigger cloud computing to process the file (step S470). The cloud computing refers to computing processing using the software and hardware resources (i.e., cloud resources) of the cloud computing server 70 or the remote device 50.

In an embodiment, if the configuration does not record the metadata of the currently processed file, the processor 35 or the processor 55 may directly provide one of the local resource and the cloud resource. In another embodiment, if the file is not stored in the cloud-synchronized folder or the local device 30 does not have a cloud-synchronized folder, the processor 35 may directly perform the local computing of local resources on the file.

In some embodiments, for the local computing, if a file is uploaded to the storage 51, the processor 35 may be disabled or may not delete the file or its cache from the storage 31, and the processor 35 may determine whether to delete the file, save the file directly, or delete the file directly after the local computing of the file is completed.

In one embodiment, for various computations, the processor 35 or the processor 55 further synchronizes the results (i.e., the results obtained by computing the file) of one or more computing resources for the file to the cloud-synchronized folder. For example, the cloud computing server 70 transmits the metadata of the computing result to the remote device 50 and/or the local device 30 and assigns the metadata to the cloud-synchronized folder to which the file belongs. For example, the local device 30 transmits the computing result and the metadata to the remote device 50 and assigns the computing result and the metadata to the cloud-synchronized folder to which the file belongs.

There are many variations in the correspondence in the configuration. In one embodiment, the computing service is thumbnail generation. The metadata of the file records the image format (e.g., images or videos). The processor 35 or the processor 55 may request the cloud resource in the computing resources to generate the thumbnail according to the image format. That is, the configuration records image format corresponding to the thumbnail generated through the cloud resource, so the computing generated by the thumbnail may be offloaded to the cloud computing server 70 or the remote device 50.

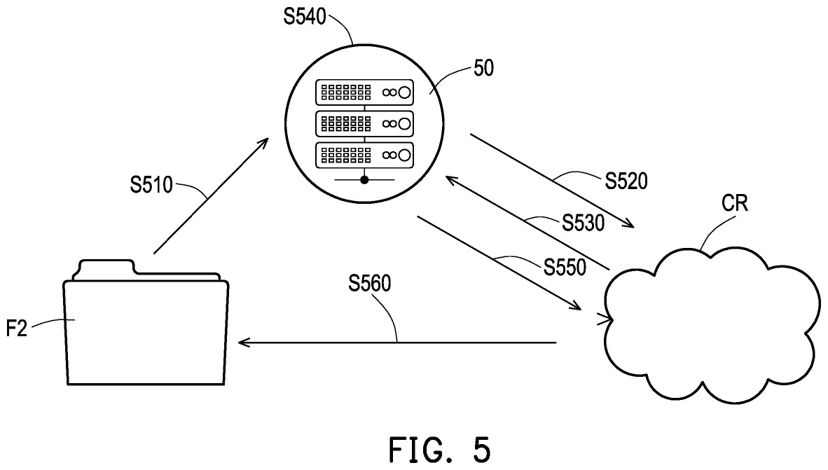

For example, FIG. 5 is a flowchart illustrating thumbnail processing according to an embodiment of the disclosure. Referring to FIG. 5, a file F2 is stored in the cloud-synchronized folder, and the remote device 50 determines that the file belongs to the image format (i.e., the image format recorded by the metadata) and calls the corresponding function accordingly (step S510). The remote device 50 calls a cloud resource CR to find the thumbnail of the file (step S520). The cloud computing server 70 transmits what is found to the remote device 50 (step S530). The remote device 50 may generate three thumbnails according to what is found by the cloud computing server 70 (step S540) and update the three thumbnails to the cloud computing server 70 (step S550). Moreover, the metadata of the three thumbnails may also be updated to the cloud-synchronized folder (step S560).

In one embodiment, the computing service is image analysis and alert. The metadata of the file records the image monitoring function. The processor 35 or the processor 55 may request the cloud resource in the computing resources to perform the image analysis and alert according to the image monitoring function. That is, the configuration records the image monitoring function corresponding to the image analysis and alert through cloud resources, so the computations of the image analysis and alert may be offloaded to the cloud computing server 70 or the remote device 50.

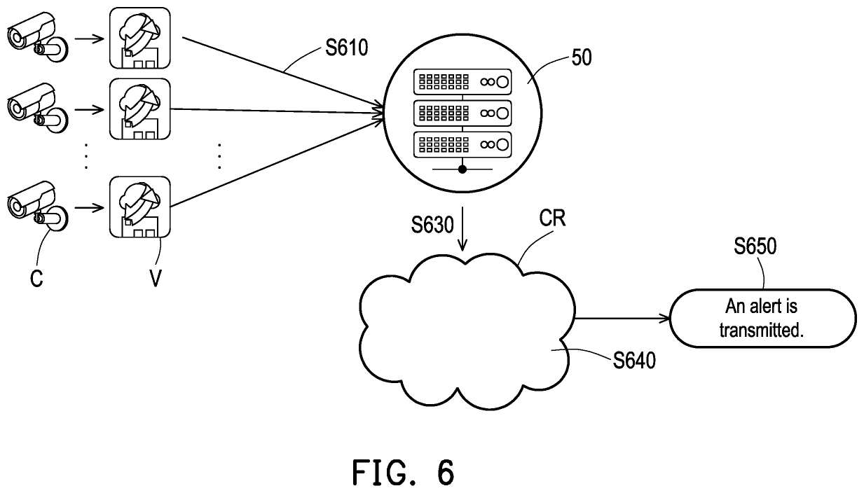

For example, FIG. 6 is a flowchart illustrating intelligent monitoring according to an embodiment of the disclosure. Referring to FIG. 6, if there are multiple camcorders C in a field to provide image monitoring. The local device 30 obtains video files V from the camcorders C. The video files V are stored in the cloud-synchronized folder, and the configuration records the video files V from the camcorder C corresponding to the image analysis and alert. The local device 30 uploads the video files V to the remote device 50 (step S610). The remote device 50 calls the cloud resource CR (step S630) and accordingly triggers the cloud computing server 70 to perform a behavior prediction analysis on the video files V (step S640). If the behavior of a character in the video files V meets the alert condition, the cloud computing server 70 may call another server to transmit an alert to the designated device (step S650).

In one embodiment, the computing service is video encoding, and the metadata of the file records the encoding request. The processor 35 or the processor 55 may request the cloud resource in the computing resources to perform the video encoding according to the encoding request. That is, the configuration records the encoding request corresponding to the video encoding through the cloud resources, so the computation of the video encoding may be offloaded to the cloud computing server 70 or the remote device 50.

Taking FIG. 6 as an example, the configuration records the video file V from the camcorder C corresponding to the video encoding. The local device 30 uploads the video files V to the remote device 50 (step S610). The remote device 50 calls the cloud resource CR (step S630) and accordingly triggers the cloud computing server 70 to convert the video files V into the H.264 format (step S640).

In one embodiment, the computing service is object identification, and the metadata of the file records the identification function. The processor 35 or the processor 55 may request the cloud resource in the computing resources to perform the object identification according to the identification function. That is, the configuration records the identification function corresponding to the object identification through the cloud resource, so the computation of the object identification may be offloaded to the cloud computing server 70 or the remote device 50.

Taking FIG. 6 as an example, the configuration records the video files V from the camcorder C corresponding to the object identification. The local device 30 uploads the video files V to the remote device 50 (step S610). The remote device 50 calls the cloud resource CR (step S630) and accordingly triggers the cloud computing server 70 to determine whether a dangerous object appears in a screen in the video files V (step S640).

Note that computing services may also be automatic marking, optical character recognition (OCR), or other applications.

Note that the synchronization of the computing result is not limited to the cloud-synchronized folder of a single local device 30. In one embodiment, multiple local devices 30 are configured with the same account or the account that allows sharing. That is, multiple local storages are provided. The processor 35 or the processor 55 may synchronize the metadata of the result of the computing service of one or more computing resources to the cloud-synchronized folder CF of the local storages LS. That is, as long as any local device 30 saves a new file to its own cloud-synchronized folder CF, the corresponding computing resource may be triggered according to the metadata of the new file, and the metadata of the result of the computing service may be provided to other local devices 30 as well.

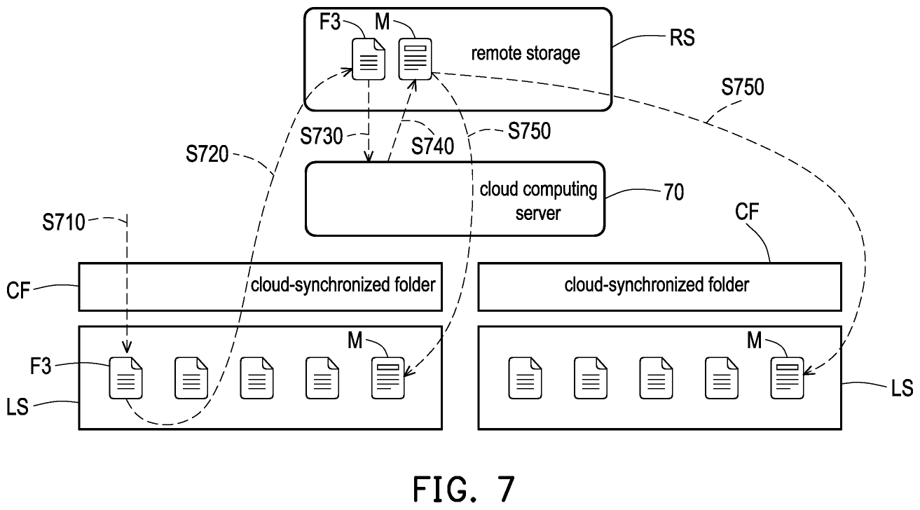

For example, FIG. 7 is a flowchart illustrating multi-device sharing according to an embodiment of the disclosure. Referring to FIG. 7, the local storage 31 (the local storage LS as shown in the drawing) stores a file F3 in its cloud-synchronized folder CF (step S710) and uploads the file F3 to the remote storage 51 (the remote storage RS as shown in the drawing) (step S720). The remote device 50 decides to select cloud resources according to the metadata of the file F3 and calls the cloud computing server 70 accordingly to provide corresponding cloud services for the file (step S730). The cloud computing server 70 transmits the result (e.g., thumbnail, alert, or transcoded video) of the computing service and its metadata M to the remote device 50 (step S740). The remote device 50 synchronizes the metadata M to the cloud-synchronized folder CF of two local devices 30 (step S750). Taking FIG. 5 as an example, the remote device 50 provides the metadata of the thumbnail to the cloud-synchronized folder CF of other local devices 30 of the same account.

Note that regarding the system architecture, the cloud-synchronized folder CF belongs to the logical layer, and both the local storage LS (equivalent to the storage 31) and the remote storage RS (equivalent to the storage 51) belong to the physical layer.

In summary, in the network-connected apparatus and the cloud data processing method of the embodiments of the disclosure, object-oriented automated data processing is provided. Appropriate computing resources are triggered according to the metadata of the files in the cloud-synchronized folder. Accordingly, computing may be offloaded to the cloud computing platform, which improves computing efficiency, reduces computing demands on edge devices, prevents unnecessary upload or download operations (which may save bandwidth and cost), and may share computing results to multiple devices.

Although the disclosure has been described with reference to the above embodiments, they are not intended to limit the disclosure. It will be apparent to one of ordinary skill in the art that modifications and changes to the described embodiments may be made without departing from the spirit and the scope of the disclosure. Accordingly, the scope of the disclosure will be defined by the attached claims and their equivalents and not by the above detailed descriptions.

What is claimed is:

1. A cloud data processing method, comprising:
storing a file to a cloud-synchronized folder, wherein at least one local storage comprises the cloud-synchronized folder;
uploading the file to a remote storage, wherein the cloud-synchronized folder stores metadata of the file uploaded to the remote storage;
identifying the metadata of the file; and
triggering at least one computing resource according to an identified result of the metadata, wherein each computing resource is used to provide a computing service to the file.

2. The cloud data processing method according to claim 1, wherein the metadata comprises at least one of a file format, a subdirectory, and an extended attribute, and the step of triggering at least one computing resource according to the identified result of the metadata comprises:
comparing at least one of the file format, the subdirectory, and the extended attribute with a plurality of computing resources, wherein the at least one computing resource comprises a cloud computing and a local computing; and
using a corresponding one of the computing resources according to a comparison result of the metadata.

3. The cloud data processing method according to claim 1, further comprising:
setting a configuration of the cloud-synchronized folder to the metadata of the file under the cloud-synchronized folder, wherein the configuration is related to using the at least one computing resource, and the at least one computing resource comprises a cloud computing and a local computing.

4. The cloud data processing method according to claim 1, further comprising:
synchronizing a result of the at least one computing resource to the cloud-synchronized folder.

5. The cloud data processing method according to claim 4, wherein the at least one local storage comprises a plurality of local storages, and the step of synchronizing the result of the at least one computing resource to the cloud-synchronized folder comprises:
synchronizing the metadata of the result of the computing service of the at least one computing resource to the local storages of the cloud-synchronized folder.

6. The cloud data processing method according to claim 1, wherein the computing service is a thumbnail generation, the metadata of the file records an image format, and the step of triggering the at least one computing resource according to the identified result of the metadata comprises:
requesting a cloud resource in the at least one computing resource to generate the thumbnail according to the image format.

7. The cloud data processing method according to claim 1, wherein the computing service is an image analysis and alert, the metadata of the file records an image monitoring function, and the step of triggering the at least one computing resource according to the identified result of the metadata comprises:
requesting a cloud resource in the at least one computing resource to perform the image analysis and alert according to the image monitoring function.

8. The cloud data processing method according to claim 1, wherein the computing service is a video encoding, the metadata of the file records an encoding request, and the step of triggering the at least one computing resource according to the identified result of the metadata comprises:
requesting a cloud resource in the at least one computing resource to perform the video encoding according to the encoding request.

9. The cloud data processing method according to claim 1, wherein the computing service is an object identification, the metadata of the file records an identification function, and the step of triggering the at least one computing resource according to the identified result of the metadata comprise:
requesting a cloud resource in the at least one computing resource to perform the object identification according to the identification function.

10. A network-connected apparatus, comprising:
a communication transceiver for transmitting or receiving data;
a first storage for storing a program code; and
a processor coupled to the communication transceiver and the first storage and configured to load and execute the program code to execute:
storing a file to a cloud-synchronized folder, wherein the first storage comprises the cloud-synchronized folder;
uploading the file to a second storage through the communication transceiver, wherein the cloud-synchronized folder stores metadata of the file, and the second storage is not located in the network-connected apparatus;
identifying the metadata of the file; and
triggering at least one computing resource according to an identified result of the metadata, wherein each computing resource is used to provide a computing service to the file.

11. The network-connected apparatus according to claim 10, wherein the metadata comprises at least one of a file format, a subdirectory, and an extended attribute, and the processor is further configured to:
compare at least one of the file format, the subdirectory, and the extended attribute with a plurality of computing resources, wherein the at least one computing resource comprises a cloud computing and a local computing; and
use a corresponding one of the computing resources according to a comparison result of the metadata.

12. The network-connected apparatus according to claim 10, wherein the processor is further configured to:
set a configuration of the cloud-synchronized folder to the metadata of the file under the cloud-synchronized folder, wherein the configuration is related to using the at least one computing resource, and the at least one computing resource comprises a cloud computing and a local computing.

13. The network-connected apparatus according to claim 10, wherein the processor is further configured to:
synchronize a result of the at least one computing resource to the cloud-synchronized folder.

14. The network-connected apparatus according to claim 13, wherein the processor is further configured to:
synchronize the metadata of the result of the computing service of the at least one computing resource to the cloud-synchronized folder of another network-connected apparatus through the communication transceiver.

15. The network-connected apparatus according to claim 10, wherein the computing service is a thumbnail generation, the metadata of the file records an image format, and the processor is further configured to:
request a cloud resource in the at least one computing resource to generate the thumbnail according to the image format.

16. The network-connected apparatus according to claim 10, wherein the computing service is an image analysis and alert, the metadata of the file records an image monitoring function, and the processor is further configured to:
request a cloud resource in the at least one computing resource to perform the image analysis and alert according to the image monitoring function.

17. The network-connected apparatus according to claim 10, wherein the computing service is a video encoding, the metadata of the file records an encoding request, and the processor is further configured to:
request a cloud resource in the at least one computing resource to perform the video encoding according to the encoding request.

18. The network-connected apparatus according to claim 10, wherein the computing service is an object identification, the metadata of the file records an identification function, and the processor is further configured to:
request a cloud resource in the at least one computing resource to perform the object identification according to the identification function.
